(19) United States
(12) Patent Application Publication
(10) Pub. No.: US 2006/0109555 A1
(43) Pub. Date: May 25, 2006

(54) Sun protection device having a plurality of segments that are oriented in parallel to one another

(75) Inventors: Peter Nitz, Gundelfingen (DE); Christopher Buhler, Freiburg (DE); Werner Platzer, Gundelfingen (DE); Tilmann Kuhn, Hinterzarten (DE); Andreas Gombert, Freiburg (DE); Benedikt Blasi, Freiburg (DE); Volker Wittwer, Freiburg (DE)

Correspondence Address: BUCHANAN INGERSOLL PC;(INCLUDING BURNS, DOANE, SWECKER & MATHIS), POST OFFICE BOX 1404, ALEXANDRIA, VA, 22313-1404, US

(73) Assignee: Fraunhofer Gesellschaft zur Forderung der Angewandten Forschung e.V., Munich (DE)

(21) Appl. No.: 10/520,632

(22) PCT Filed: Jul. 10, 2003
(86) PCT No.: PCT/EP03/07499

§ 371 Date: Sep. 9, 2005

(30) Foreign Application Priority Data
Jul. 10, 2002 (DE) 102311390

(51) Int. Cl. G02B 27/00; E06B 9/386

(52) U.S. Cl. 359/593

(57) ABSTRACT

The invention relates to a sun protection device that has a plurality of segments that are spaced apart from one another parallel to their longitudinal direction and that are received so as to be rotatable about their longitudinal axis. The segments have respective segment top surfaces on which a plurality of optical concentrator structure elements from an at least partially transparent dielectric material, so-called CPCs (Compound Parabolic Concentrators) are provided. Said concentrators have a surface of incidence and one planar or curved receiving surface and are oriented with their receiving surface toward the segment top surface. The invention is characterized in that the segment top surface, at an angle to its longitudinal direction, is at least partially curved or edged, the segment top surface is reflecting or opaque, and the CPCs adjoin the segment top surface with their receiving surface directly or across at least one coupling layer or are spaced apart and disposed opposite the segment top surface.

### TECHNICAL FIELD

The present relates to a sun protection device having a plurality of segments that are disposed spaced apart in parallel in longitudinal direction and borne rotatable about their longitudinal axis. Each segment has a top surface on which a plurality of optical concentrator structural elements made of an at least partially transparent dielectric material, so-called CPCs (compound parabolic concentrators), is provided. The concentrators are provided with a surface of incidence as well as a planar or curved receiving surface and are oriented with the receiving surface directed toward the top surface of the segment surface.

### PRIOR ART

A generic device is disclosed in DE 196 13 222 A1, which describes a stationary device for shading direct sunlight in glazing by using light-concentrating CPCs (compound parabolic concentrators) type structures.

The CPCs serve to selectively block sunlight directed on the light-concentrating elements.

Basically CPCs are able to concentrate light falling upon the surface of incidence of a CPC from a certain acceptance angle range by way of total reflection onto an in comparison to the surface of incidence, smaller dimensioned receiving surface. The stationary shading system described in the preceding printed publication is distinguished by the CPCs' receiving surface being completely or partially reflecting thereby reflecting the light fractions totally reflected inside the CPCs back within the same angle range from which they fall upon the CPCs. The fractions of light coming from the other angle ranges and the fractions of light falling upon the CPCs pass the otherwise transparent concentration structures by way of optical refraction.

In one preferred embodiment of the printed publication, the CPCs are arranged on the top side of the straight segments, for example, disposed in the form of a segmented blind with a multiplicity of single segments oriented in horizontal direction and arranged one above the other in vertical direction behind the glazing. The single segments are borne rotatable in longitudinal direction in order in this way to be able to adapt the shading areas provided by the individual CPCs dynamically to the current position of the sun.

The prior art segmented blind provided with CPCs having a plurality of horizontally oriented segments disposed spaced apart in vertical direction, however, has a number of drawbacks, which are inherent in the system. Due to the straight planar construction of the single segments on whose top side the CPC structures are disposed facing the incidence of light, the form stability of each single segment is strongly limited, in particular when the segments are arranged horizontally. As the single segments usually are held at the two outer edges or at least only at a few points by bearing or adjusting structures, for example in the form of retaining or adjusting pulls, long segments often sag markedly pulled down by the segment's own weight on the segmented structure. As a consequence only relatively narrow window surfaces can be shaded using correspondingly short but stable segments.

A further striking disturbing optical feature of such a type segmented blind is caused by the underside of the segments being directly lit by the light reflected at the top side of the segment of the immediately adjacent segment disposed in vertical direction below the lit underside. Such irritating reflections on the underside of the segments are particularly noticeable when the segments are tilted from a horizontal orientation, for example, when the position of the sun is low, inevitably drawing the attention of someone inside the room to the underside of the single segments.

Moreover, in the case of an essentially horizontal position of the planar segments, segment surfaces which are directly irradiated by the incident light can enter a viewer's field of vision, which can lead to glaring.

### DESCRIPTION OF THE INVENTION

The object of the present invention is to further develop a sun protection device having a plurality of segments as described in the preceding in such a manner that the sun protection device is able to cover wide glazing without having to take into account the aforementioned type sagging effects caused by the own weight of the single segments. Furthermore, the object is to prevent, respectively reduce the disturbing effect of the underside of the segments being lit due to reciprocal reflection of adjacent segments, especially when the single segments are tilted horizontally.

The solution of the object of the present invention is set forth in claim 1. Advantageous features are the subject matter of the subclaims and the description with reference to the preferred embodiments.

A key element of the present invention is to further develop a sun protection device having a plurality of segments disposed apart in parallel and borne rotatable in longitudinal direction and each having provided with a segment top side on which is provided a multiplicity of optical concentration structural elements made of at least partially transparent dielectric material, so-called CPCs, each of which having a surface of incidence as well as a planar or curved receiving surface and being oriented with the receiving surface facing the top side of the segment in such a manner that the segment top side is at least partially curved or edged transverse to their longitudinal expansion. Such a geometric shape of each single segment improves the inherent stability in the longitudinal expansion of each single segment considerably thereby preventing the precedingly described sagging due to the segments' own weight. Furthermore, the top side of the segments are constructed partially reflecting or opaque thereby ensuring that the sunlight falling in the acceptance angle range of the CPCs is reflected within exactly the same angle range directed in opposite direction. For this purpose, the CPCs adjoining directly with their receiving surface or via at least a coupling layer-to the top side of the segments or are disposed at a distance from the top side of the segments.

By placing the receiving surfaces on an at least partially reflecting top side of the segment or by approximating them thereto, the receiving surfaces are directly or indirectly “provided” with reflecting properties thereby obviating under circumstances a separate production step in which the receiving surfaces have to be provided with a reflecting coat in order to ensure the desired function, which can be very complicated in particular if the CPCs are constructed as a microstructure.

The curvature or the edged construction of the top side of the segments transverse to their longitudinal expansion grants the segments greater inherent stability in longitudinal direction and moreover permits reduction of, by means of corresponding curved shapes and edged courses, direct irradiation of the underside of the segments by the sunlight reflected at the respective adjacent top side of the segments. In the same manner, direct view of the directly lit top side of the segments or of the underside of the segments lit by reflection is prevented by means of a corresponding course of curvature despite the segments being tilted in relation to the horizontals.

A particular aspect of the sun protection device designed according to the present invention relates to the ability to produce CPC structures distributed over large surfaces in the form of sunlight transparent foils which can be simply placed on the top side of the segments. Production of such type CPC foils occurs by way of lithographic process steps, molding procedures or stamping processes, which will not be dealt with in more detail herein. But rather in this context, it is to be noted that the CPC structures themselves possess no inherent surface stability and in combination with a segment are not able to or only negligibly able to increase the inherent stability of the segment.

This is in this that the invented sun protection device differs from the device described in the printed publication cited in the preceding as it provides macroscopic CPCs that themselves can represent a CPC arrangement capable of carrying itself.

### BRIEF DESCRIPTION OF THE DRAWINGS

The present invention is made more apparent by way of example in the following using preferred embodiments with reference to the drawings without the intention of limiting the scope or spirit of the overall invention.

FIGS. 1 to 7 show various preferred embodiments of curved segments having CPCs disposed on the top side of the segments.

### WAYS TO CARRYING OUT THE INVENTION, COMMERCIAL APPLICABILITY

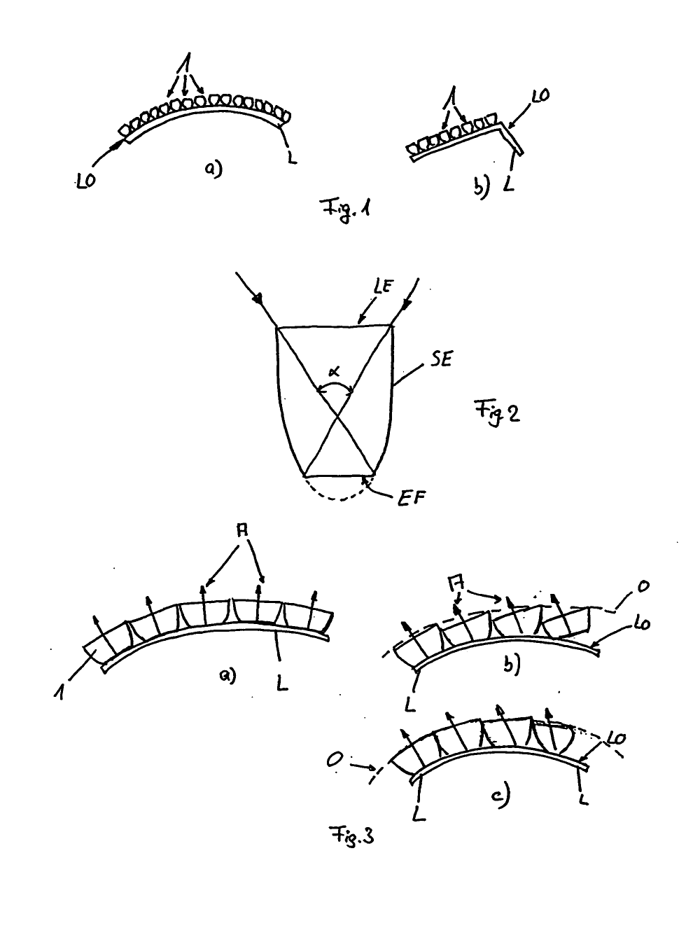

FIGS. 1a and b show cross-sectional representations of a curved (see FIG. 1a) and an edged (see FIG. 1b) segment L on whose segment top side (LO) a plurality of single CPCs 1 are disposed. The single CPCs 1 are arranged side by side or in a translation invariant manner in the longitudinal expansion of segments L, not depicted in FIG. 1, thereby yielding a strip-like or array-like arrangement of single CPCs which overlap at least parts of the segment surface LO.

Both the arched curvature transverse to the longitudinal direction of the segment L shown in FIG. 1a and the folded edge placed in longitudinal direction to segment L according to the preferred embodiment of FIG. 1b increase the inherent stability in longitudinal direction, permitting thereby producing segments in lengths of several meters which can be attached simply at the lateral edges, respectively at a few holding points, without sagging.

FIG. 2 shows a schematic cross section of an as such prior art CPC structure having a surface of incidence LE and a receiving surface EF. The surface of incidence LE and the receiving surface EF are joined by parabolic lateral surfaces SE at the interfaces of which rays of light falling upon the surface of incidence LE within the acceptance angle range α are totally reflected and concentrated onto the receiving surface EF. The broken line under the receiving surface EF should show that the receiving surface EF does not have to be solely a plane surface, but rather can also have a, for example, continuously curved surface form.

In order to effectively block out sunlight, at least rays of sun falling from the acceptance angle range α upon the light entry surface LE of a CPC, the receiving surface EF is covered with a reflecting layer or it is disposed at least close to the reflecting top side of the segment where the rays of light are correspondingly reflected. Thus, it is ensured that the sunlight falling in the acceptance angle range are reflected back again in the same angle range.

In contrast to the CPC segments of DE 196 13 222 A1, in which fractions of light from the remaining angle ranges reach the interior of a room through the CPC structure as diffuse light by way of refraction, in the present invention fractions of light reach the room interior if at all by reflection due to the reflecting or at least opaque construction of the entire segment surface LO. In this way, this light obtains a tendentiously upwards directed preferable direction and simultaneously contributes to improved daylight illumination in the interior of a room.

As already mentioned in the preceding, the CPC structures can be constructed in their planar arrangement by way of lithographic processes and subsequently by molding and stamping processes as light transparent foils and joined to the correspondingly curved top side of segment L.

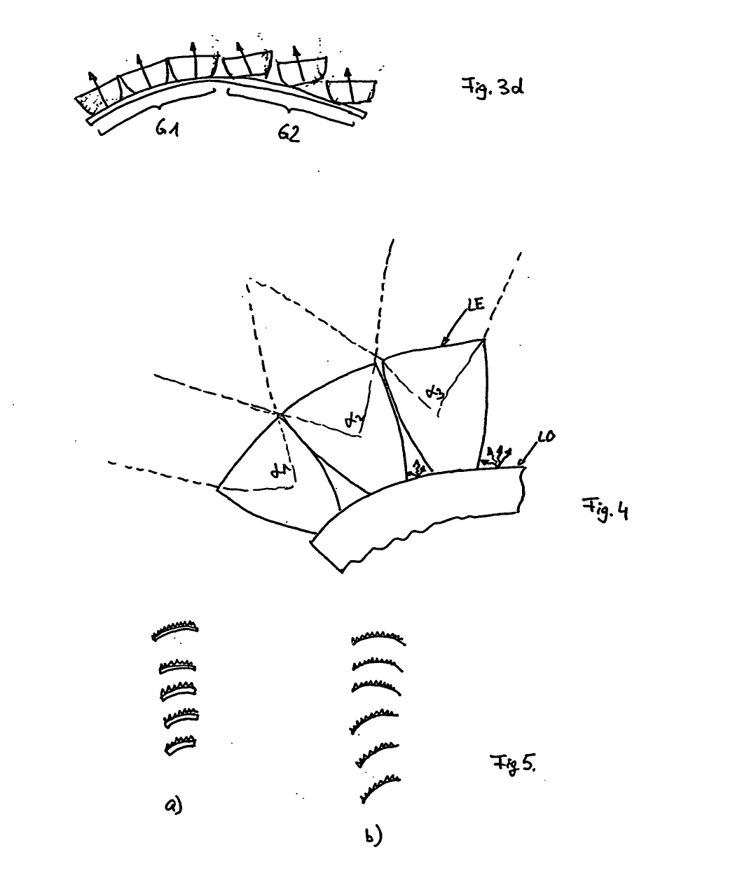

The preferred embodiments according to FIGS. 3a to d show fundamentally different principles of arrangements with which the single CPCs can be placed on the surface of the segments.

FIG. 3a shows an arrangement of identical CPCs, which are placed with regard to their single acceptance angle ranges, which are represented in the drawing by the respective central direction A, on the segment surface based on the local curvature behavior. Thus, the single acceptance angle ranges of the single CPCs point in different directions. In contrast to this, FIG. 3b shows a group of CPCs 1 whose spatial orientation of the single acceptance angle ranges A are aligned in parallel. In this case too, the single CPCs are designed identically, but their inclines differ from the top side of the segment LO. In the production of such a CPC arrangement designed as a foil, the curvature behavior of the top side of the segment, on which the foil is to be correspondingly placed, therefore, has to be taken into account already in fabricating the single CPCs and their individual arrangement in relation to the segment top side.

Furthermore, it is pointed our that in the preferred embodiment according to FIG. 3b, the incidence surfaces LE of the single CPCs 1 do not lie in a common surface O. But rather the latter property is reflected in the preferred embodiment according to FIG. 3c, in which the single CPCs are oriented in the same manner relative to each other with regard to their individual acceptance angle ranges and, furthermore, describe a common surface O with their single incidence surfaces LF. Such a type, preferably smooth surface O which runs in parallel to the top side of the segment LO is much less-susceptible to soiling than the preferred embodiment shown in FIG. 3b.

FIG. 3d shows a segment top side LO on which two groups G1 and G2 CPCs are disposed. Group G1 is composed of CPCs 1 the orientation of whose acceptance angle ranges is dependent on the local curvature behavior of the segment top side. In contrast to this, group G2 has CPC elements the orientation of whose acceptance angle ranges are the same. The preferred embodiment clearly indicates that any desired variation and combination of the possible design of the CPC mentioned in the preceding is possible with reference to FIGS. 3a to c on a single segment surface depending on the illumination situation.

FIG. 4 shows a detail representation of three CPC structures 1 placed on a segment top side. The acceptance angle ranges α₁, α₂, and α₃ are each selected in such a manner that they overlap. In this manner, it is ensured that sunlight from an incidence direction lying in the overlapping region is reflected back by all the CPCs of the group by total reflection and reflection at the top side of the segment. The arrangement can also reflect direct sunlight completely if the segment (therefore the group) is aligned as a whole in such a manner that the sun stands in the overlapping angle range.

Similarly, the detail representation in FIG. 4 shows that the segment top side LO is designed at least partially reflecting or opaque so that the segment designed according to the present invention cannot be penetrated by diffuse sky radiation either.

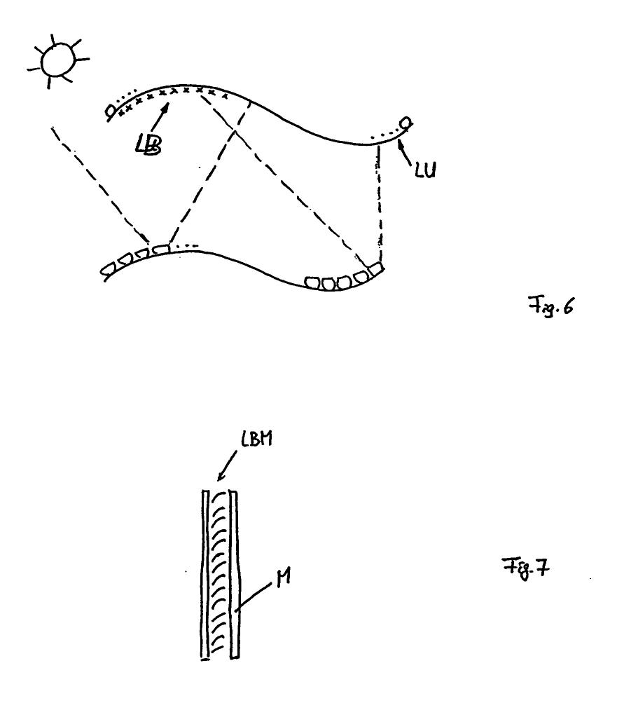

The sun protection device provides a plurality of horizontally oriented and disposed in parallel single segments L, which are arranged vertically one above the other. In a preferred embodiment, all the segments L are identically inclined in relation to their longitudinal axes. This situation is sketched in the cross-sectional representation according to FIG. 5a. Similarly, it is feasible to combine in such a type segmented blind single segments with the same incline but with a different transverse incline in relation to different groups. This situation is depicted in FIG. 5b in which the incline of the top three segments is flatter than that of the bottom three.

FIG. 6 shows two segments L disposed vertically one above the other with an arched segment curvature. In this case, the CPCs 1 are arranged in the region of the longitudinal edge of segment L facing sun radiation in such a manner that the sunlight falling upon the CPCs is essentially retro-reflected in the sense of back reflection in that angle range from which the light falls upon the CPCS. Thus the strict retro-reflection requirement in which the rays of light must reflect back into itself is not mandatory. The CPCs disposed in the region of the longitudinal edges facing away from the sun radiation face the vertically adjacent underside of the segment lying above. In order to prevent directly lit segment undersides visibly facing the room interior, the advantageously curved segment covers the directly lit regions LB of the segment underside LU. Furthermore, in order to prevent glare on the underside of the segment, the segment underside is designed in a diffusely scattering manner, mat and/or dark.

The CPCs can be attached on the top side of each single segment in various ways. The CPCs can be glued singly or bonded in a foil with the aid of a transparent coupling layer, for example an adhesive layer on the top side of the segment. Furthermore, the foil-like CPC arrangement can be placed loosely on the top side of the segment so that at least a thin layer of air remains between the single receiving surfaces of the CPCs and the surface of the segment. Attachment of the CPCs to the segment surface occurs, for example, via the edge region of the CPCs with the segment using corresponding clamp or adhesive joining. Depending on the shape of the receiving surfaces of the single CPCs, i.e. curved or planar, using suited transparent coupling layers direct optical contact can be achieved or not.

Another advantageous embodiment is yielded if a coupling layer is employed that is not transparent but rather is itself reflecting (white or reflecting). Then the coupling layer assumes the reflection of the receiving surfaces and the properties of the segment surface LO are only secondarily, respectively only essentially, responsible for the reflection of diffuse sky light, which falls outside the acceptance range. In this case the segment surface can even be constructed especially according to the requirements of diffuse light reflection without impairing the retro-reflecting property of the segments for direct sunlight.

This idea can even be carried further by filling the intermediate spaces between two adjacent CPCs with reflecting material due to which reflection occurs at the coupling layer instead of the dielectric total reflection at the covered areas of the flanks.

The sun protection device constructed according to the present invention is suited in a particularly advantageous manner as a segmented blind LBH that can be placed in the intermediate space in multipane glazing M (FIG. 7).

For reasons of comprehensiveness, it is pointed out that ideally CPC structures have a parabolic lateral periphery which is joined to the incidence surface via a circumferential edge. Especially if the CPCs are executed as microstructures, the periphery cannot assume the ideal and theoretically exact parabolic shape due to production-based manufacturing tolerances, but rather it deviates from the ideal shape. Such deviations should, however, be part of the technical teaching disclosed in this step as long as the optical function and the general shape of the CPC structure is largely retained.

### List of Reference Numbers

1 CPC
L segment
LO top side of the segment
LE incidence surface
EF receiving surface
A central orientation of the acceptance angle range
G1,G2 groups of CPCs
α₁,α₂,α₃ acceptance angle ranges
LB directly lit segment underside
LU segment underside
LBM segmented blind
M multipane glazing

1. A sun protection device having a plurality of segments disposed apart in parallel in longitudinal direction and borne rotatable about their longitudinal axis and each provided with a segment top side, on which a plurality of optical concentrating structural elements of at least partially transparent dielectric material, so-called CPCs (compound parabolic concentrators) is provided, each having a surface of incidence (LE) and a planar or curved receiving surface (EF) which are oriented with said receiving surface (EF) directed toward said segment top side,
wherein said segment top side is shaped at least partially curved or edged transverse to its longitudinal expansion,
said segment top side is designed reflecting or opaque, and
said CPCs are disposed with their receiving surface (EF) directly adjacent to said segment top side or at least via a coupling layer or at a distance facing said segment top side.

2. The sun protection device according to claim 1,
wherein said CPCs are disposed side by side or in a translation invariant manner on said segment top side in longitudinal direction to the longitudinal expansion thereof and one behind the other in the curved transverse direction in at least one continuous group in such a manner that all said CPCs of said group are constructed identically and
that said incidence surfaces (LE) and receiving surfaces (EF) of said CPCs of said group are oriented based on the curvature behavior of said segment top side.

3. The sun protection device according to claim 1,
wherein said CPCs are disposed side by side or in a translation invariant manner on said segment top side in longitudinal direction to the longitudinal expansion thereof and one behind the other in the curved transverse direction in at least one continuous group in such a manner that at least two said CPCs of said group disposed directly behind each other are disposed with identical orientation independent of the curvature behavior of said segment top side.

4. The sun protection device according to claim 3,
wherein said CPCs of said group are all designed identically.

5. The sun protection device according to claim 3,
wherein said CPCs of said group are designed differently, and the incidence surfaces of said CPCs form a surface running in parallel to said segment top side.

6. The sun protection device according to claim 2,
wherein said segment top side is provided with groups of CPCs which are designed according to claim 2.

7. The sun protection device according to claim 1,
wherein said CPCs are each provided with an acceptance angle range (AB) in which rays of light penetrate said CPC via said incidence surface (LE) and can be concentrated by way of total reflection upon said receiving surface (EF), and
said acceptance angle range (AB) of said CPCs is selected based on the curvature behavior of said segments in transverse direction in such a manner that said acceptance angle ranges (AB1 and AB2) of two adjacent said CPCs lying one behind the other (CPC1 and CPC2) overlap.

8. The sun protection device according to claim 1,
wherein said segment top sides of a group of adjacent segments are oriented in the same direction.

9. The sun protection device according to claim 8,
wherein at least two groups of adjacent segments are provided, and
the segment top sides of the segments in the first group have uniform orientation differing from the uniform orientation of the segment top sides of the segments in the second group.

10. The sun protection device according to claim 1,
wherein the segments all have a diffuse-light-scattering and/or diffuse-light-absorbing segment underside.

11. The sun protection device according to claim 10,
wherein said segment underside is provided with a diffuse-light-scattering structured foil.

12. The sun protection device according to claim 1,
wherein said CPCs are designed as a continuous layer structure which can be placed on said segment top side.

13. The sun protection device according to claim 12,
wherein said layer structure is designed as a type foil which can be glued on or otherwise attached on said segment top side.

14. The sun protection device according to claim 1,
wherein said CPCs each have a periphery which is provided with a reflecting coat and connects said incidence surface (LE) and said receiving surface (EF).

15. The sun protection device according to claim 14,
wherein said receiving surface (EF) is provided with a reflecting coat.

16. The sun protection device according to claim 1,
wherein said segments are disposed horizontally inside an opening in the facade of a building.

17. The sun protection device according to claim 16,
wherein the segment top sides are oriented facing the sun radiation,
said CPCs are disposed in the region of the longitudinal edges of said segments facing the sun radiation in such a manner that the sunlight falling upon said CPCs is largely “retro”-reflected, and
said CPCs disposed in the region of the longitudinal edges facing away from the sun radiation face in the direction of the vertically adjacent above-lying segment underside.

18. The sun protection device according to claim 1,
wherein said coupling layer is designed transparent or reflecting.

19. The sun protection device according to claim 1,
wherein said coupling layer completely or partially fills the intermediate spaces between adjacent said CPCs.

20. Use of the sun protection device according to claim 1, as a type segmented blind which is provided in the intermediate space between panes of multipane glazing.
